(19) United States
(12) Patent Application Publication
(10) Pub. No.: US 2016/0066605 A1
(43) Pub. Date: Mar. 10, 2016

(54) POPCORN POPPER

(71) Applicant: Chef'n Corporation, Seattle, WA (US)

(72) Inventor: Adam A. Jossem, Seattle, WA (US)

(21) Appl. No.: 14/847,898

(22) Filed: Sep. 8, 2015

Related U.S. Application Data
(60) Provisional application No. 62/047,497, filed on Sep. 8, 2014.

(51) Int. Cl. A23L 1/18

(52) U.S. Cl. CPC A23L 1/1812

(57) ABSTRACT

Embodiments of the device incorporate a container having a bowl section and a lid section. The bowl section has a base and a wall surrounding the base and terminating at its upper end in a rim. The lid section comprises a plurality of first and second panels that are hingedly coupled together. The first panels are hingedly coupled about the rim to pivot with respect to the bowl between open and closed configurations. The second panels are hingedly coupled to each other and to the first panels to substantially fill the spaces between the first panels when the first panels are in the open configuration. The second panels are also configured to at least partially fold with respect to the first panels and each other when the first panels are in the closed configuration. During use, the first panels can be moved into the closed configuration after corn kernels are placed in the bowl section to help retain heat within the container during popping. During popping, the corn kernels can urge the first panels from the closed configuration toward the open configuration as they pop inside the container, opening the lid section. After the popcorn has popped, the first and second panels can help retain the popped corn kernels in the container as they are eaten.

### BACKGROUND OF THE INVENTION

### Field of the Invention

The present disclosure generally is related to kitchen tools, and more particularly, to tools for use when popping corn kernels.

### BRIEF SUMMARY OF THE INVENTION

The present disclosure is directed toward devices and methods for use in making and holding popcorn. Embodiments of the device incorporate a container having a bowl section and a lid section. The bowl section of the container has a base and a wall surrounding the base. The wall terminates at its upper end in a rim. The lid section of the container comprises a plurality of first and second panels that are hingedly coupled together. The first panels are hingedly coupled about the rim of the bowl to pivot with respect to the bowl between a closed configuration in which the first panels substantially cover the bowl, and an open configuration in which the first panels are spaced apart from each other to allow a user to remove popcorn from the bowl. The second panels are hingedly coupled to each other and to the first panels to substantially fill the spaces between the first panels when the first panels are moved from the closed configuration toward the open configuration. The second panels are also configured to at least partially fold with respect to the first panels and each other when the first panels are moved from the open configuration toward the closed configuration. During use, the first panels can be moved into the closed configuration after corn kernels are placed in the bowl section to help retain heat within the container during popping. During popping, the corn kernels can urge the first panels from the closed configuration toward the open configuration as they pop inside the container, opening the lid section. Then, after the popcorn has popped, the first and second panels can help retain the popped corn kernels in the container as they are eaten.

### BRIEF DESCRIPTION OF THE SEVERAL VIEWS OF THE DRAWING(S)

FIG. 1 is an isometric view of a container for popping corn according to one embodiment.

FIG. 2 is a front elevation view of the container of FIG. 1.

FIG. 3 is a side elevation view of the container of FIG. 1.

FIG. 4 is a top plan view of the container of FIG. 1.

FIG. 5 is a bottom plan view of the container of FIG. 1.

FIG. 6 is a top plan view depicting one step in a method for making popcorn according to one embodiment.

FIG. 7 is a top plan view depicting another step in the method for making popcorn according to the one embodiment.

FIG. 8 is top plan view depicting yet another step in the method of making popcorn according to the one embodiment.

### DETAILED DESCRIPTION

The present disclosure is directed toward devices and methods that can be used when popping corn kernels to make popcorn. Specific embodiments of such devices and methods are described below in connection with the enclosed figures. An individual of ordinary skill in the art, having reviewed this entire disclosure, will appreciate that changes can be made and details omitted without deviating from the spirit of the invention. Accordingly, the scope of the invention should be construed based only on the claims.

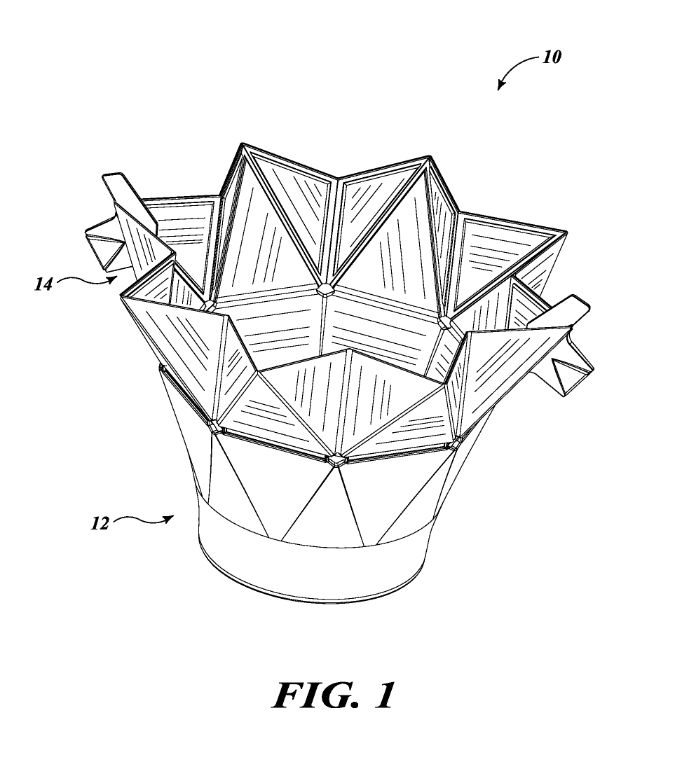

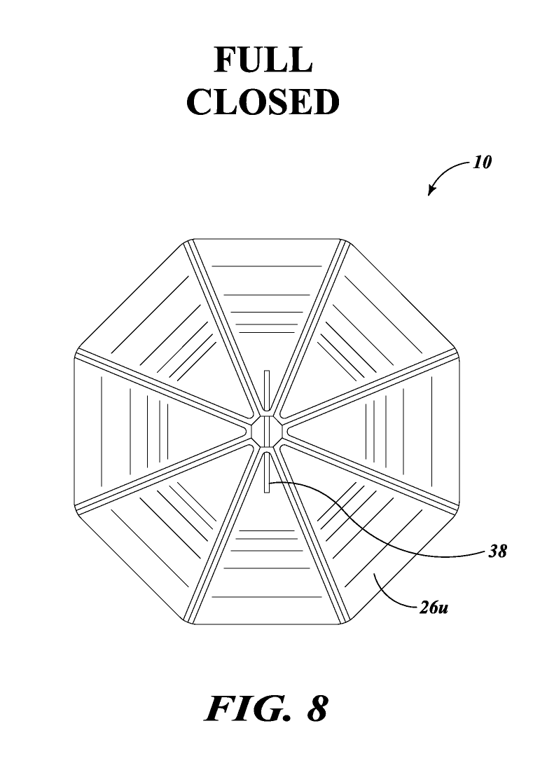

As generally illustrated in FIG. 1, the present disclosure is directed toward a container 10 for popping corn kernels to make popcorn, and for subsequently eating the popcorn from the container. The container generally comprises a bowl section 12 and a lid section 14. The container 10 is shown in FIG. 1 in an open configuration from which a user can eat popcorn. For comparison purposes, the container 10 is shown in FIG. 8 in a closed configuration, as viewed from directly above.

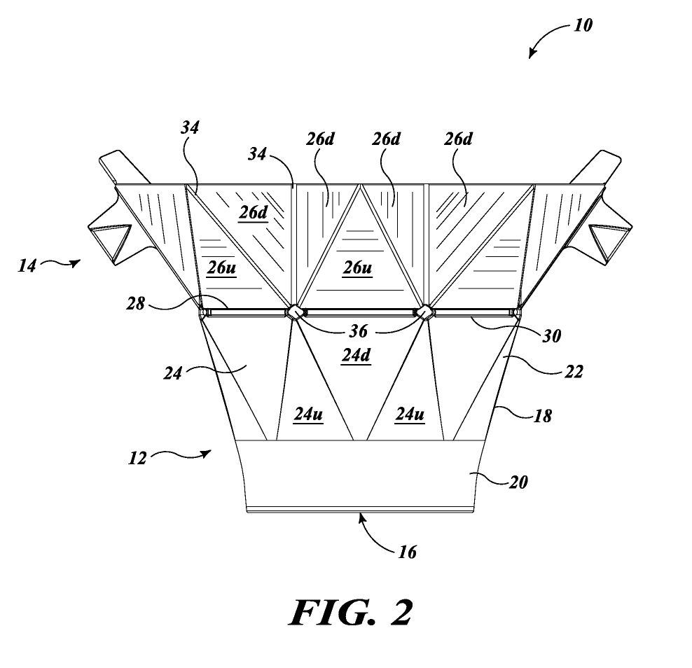

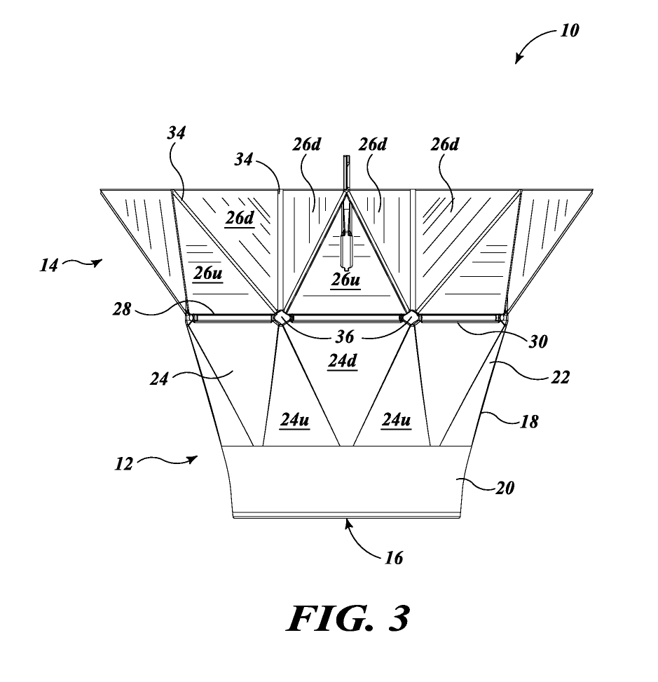

As better illustrated in FIGS. 2 and 3, the bowl section 12 of the illustrated container 10 incorporates a base 16 surrounded by a wall 18. A lower portion 20 of the illustrated wall 18 has a slightly frusto-conical shape, while an upper portion 22 is formed from a configuration of triangles 24, with upward-pointing triangles 24U having their apexes pointing upwards (as oriented in the figures) and downward-pointing triangles 24D having their apexes pointing downward. In the illustrated embodiment, the triangles 24 alternate as you move around the wall 18, with upward-pointing triangles 24U abutting downward-pointing triangles on each side. The upward-pointing triangles 24U in the illustrated embodiment are narrower than the downward-pointing triangles 24D, making the bowl section 12 wider at the top than the bottom. The bottom of the wall 18 and the base 16 are substantially circular, while the top of the wall is octagonal (see FIG. 8).

The illustrated lid section 14 is similarly made up of a ring of triangular panels 26; however, as described below, because the lid section 14 opens and closes, while the wall 18 is relatively rigid, the configuration of panels is different from that of the triangles 24 making up the upper portion 22 of the wall 18. In the illustrated embodiment, eight upward-pointing panels 26U are arranged with their bases 28 aligned with each other. The bases 28 of the upward-pointing panels 26U are attached by live hinges to the bases 30 of the downwardly-pointing triangles 24D in the wall 18. As a result, the eight upward pointing panels 26U can pivot between the open configuration of FIGS. 1-3, to the closed configuration of FIG. 8. In the closed configuration, the eight upward-pointing panels 26U form eight “slices” of an octagonal “pie” forming the lid of the container 10.

To allow the lid section 14 to open and form a continuous surface around the perimeter of the open container, while also allowing the lid section 14 to close, the upward-pointing panels 26U are each connected to each other, side-by-side, by vertically-bisected downward-pointing panels 26D. When the lid section 14 is opened as widely as possible, the downward-pointing panels 26D form flat, isosceles triangles. When the lid section 14 is closed, the downward-pointing panels 26D fold onto each other, substantially eliminating the space between the sides of adjacent upward-pointing panels 26U.

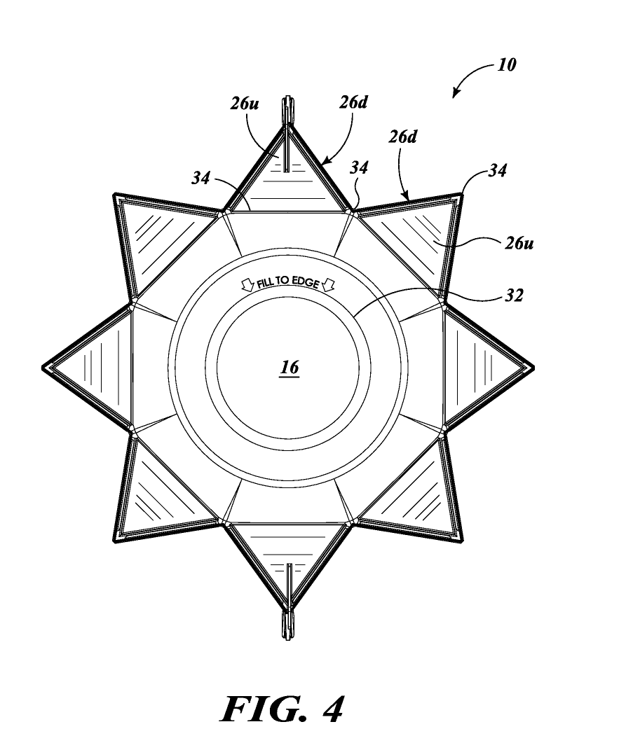

As seen in FIG. 4, when the lid section 14 is in a configuration between fully open and fully closed, the upward-pointing panels 26U are flared slightly wide than vertical, while the downward-pointing panels 26D are oriented vertically. The downward-pointing panels 26D are partially folded inwards toward each other. If the upward-pointing panels 26U were moved outward from this configuration, the downward-pointing panels 26D would approach alignment until they are co-planar. If the upward-pointing panels 26U were moved toward the closed configuration, the angle between the adjacent downward-pointing panels 26D would be reduced until it approached zero.

In the illustrated embodiment, each of the panels 26 is connected to each adjacent panel with a living hinge 34. Similarly, each of the upward-pointing panels 26U is connected to the adjacent downward-facing triangle 24D by a living hinge 34. The living hinges 34 allow the lid section 14 to move between the open and closed configurations without the panels 26 or the triangles 24 having to bend, flex or otherwise deform.

As best shown in FIG. 4, the base 16 in the illustrated embodiment is provided with a “fill line” 32 to visually inform the user how high to fill the container 10 with un-popped corn kernels to pop enough popcorn to fill the container, but not so much that it overflows.

As best shown in FIGS. 2 and 3, the container 10 incorporates openings 36. The openings 36 can be sized, shaped and positioned about the container 10 to allow stem to escape during the popping process.

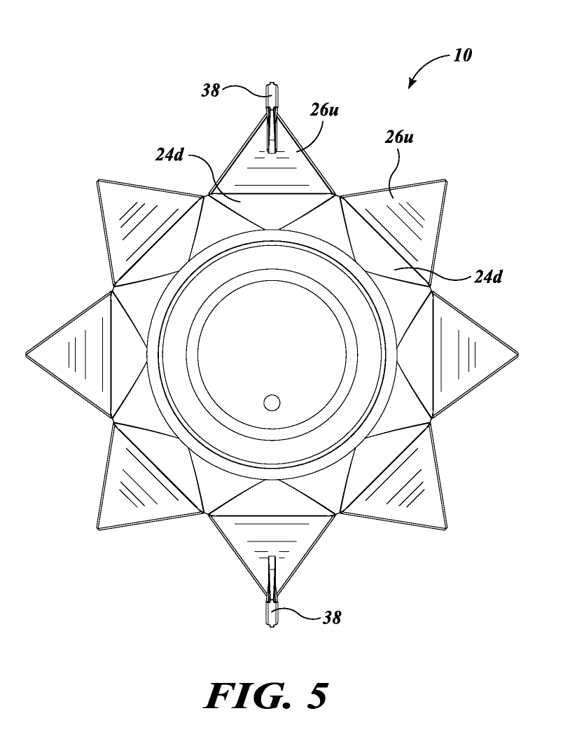

As best shown in FIG. 5, the outside of the lid section 14 can incorporate tabs 38 to facilitate the opening of the lid section. In the illustrated embodiment, tabs 38 project from the apexes of two opposing upward-pointing panels 26U. Because the panels 26 are all connected to each other by living hinges 34, moving the opposing panels 26 outward will result in all of the panels 26 making up the lid section 14 moving outward, opening the container 10.

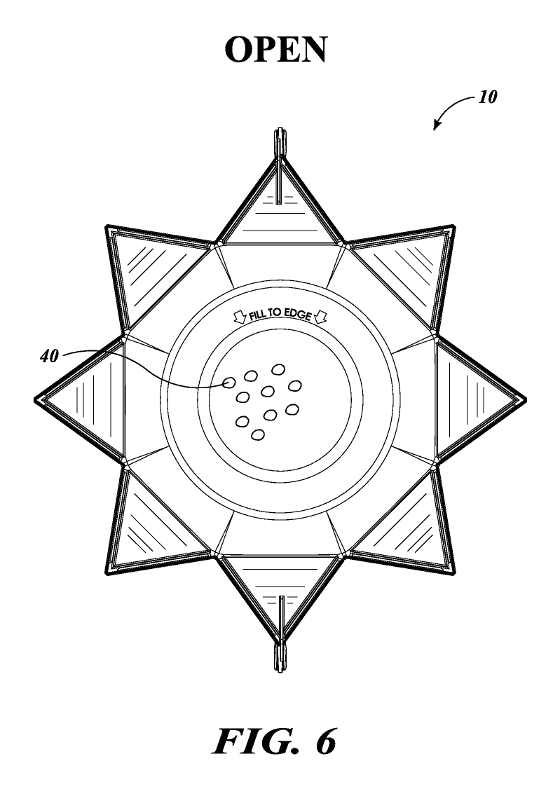

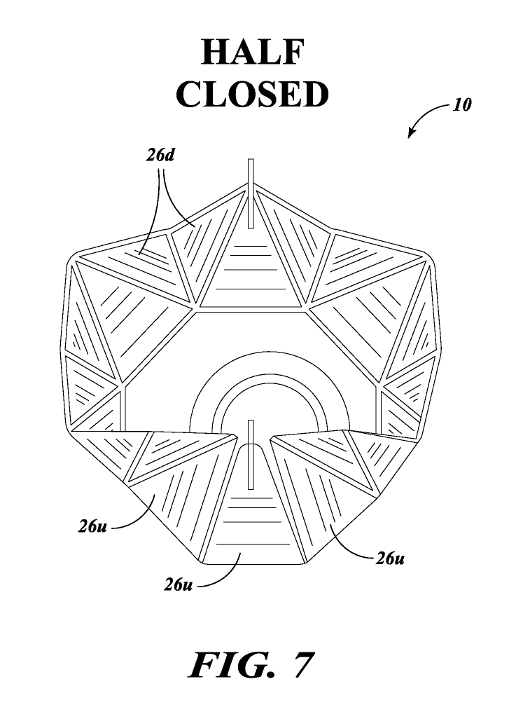

FIGS. 6, 7 and 8 show a progression of one method of making popcorn. In Figure corn kernels 40 are placed in the bottom of the container 10. The user can fill the container 10 to a point up to the fill line 32, if desired. In FIG. 7, the user begins pivoting the upward-pointing panels 26U towards each other such that the downward-facing panels 26D begin folding against themselves. In FIG. 8, the user has fully closed the lid section 14 of the container. The user can then put the container 10 into a microwave to cook the corn kernels 40 to make popcorn. In some embodiments, as the corn kernels 40 pop, the expanding corn kernels force the lid section 14 open again. If the lid section 14 does not open automatically, the user can cautiously pull the tabs 38 to open the lid section and expose the popcorn for eating.

The above description discusses the details shown in the enclosed figures. An individual of ordinary skill in the art, having reviewed this entire disclosure, will appreciate that many variations could be made to the illustrated and described embodiment without deviating from the spirit of the invention.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device for use in making and holding popcorn, the device comprising:
a container having a bowl section and a lid section, the bowl section having a base and a wall surrounding the base, the wall terminating at its upper end in a rim;
the lid section comprising a plurality of first and second panels hingedly coupled together;
the first panels being hingedly coupled about the rim of the bowl to pivot with respect to the bowl between a closed configuration in which the first panels substantially cover the bowl, and an open configuration in which the first panels are spaced apart from each other to allow a user to remove popcorn from the bowl;
the second panels being hingedly coupled to each other and to the first panels to substantially fill the spaces between the first panels when the first panels are moved from the closed configuration toward the open configuration, and being configured to at least partially fold with respect to the first panels and each other when the first panels are moved from the open configuration toward the closed configuration; whereby
the first panels can be moved into the closed configuration after a plurality of corn kernels are placed in the bowl section to help retain heat within the container during popping; the corn kernels can urge the first panels from the closed configuration toward the open configuration as they pop inside the container; and the first and second panels can retain the popped corn kernels in the container after they have popped.

2. The device for use in making and holding popcorn of claim 1, further comprising:
a first plurality of living hinges between the first panels and the rim of the bowl and configured to hingedly couple the first panels to the rim of the bowl.

3. The device for use in making and holding popcorn of claim 2, further comprising:
a second plurality of living hinges between the first panels and the second panels and configured to hingedly couple the first panels to the second panels.

4. The device for use in making and holding popcorn of claim 1, wherein:
the bowl section includes an upper portion and a lower portion, the upper portion formed from a plurality triangle shaped panels.

5. The device for use in making and holding popcorn of claim 4, wherein:
the plurality of triangle shaped panels including upward-pointing triangles having respective apexes pointing upwards, towards the rim, and downward-pointing triangles having respective apexes pointing downward, away from the rim.

6. The device for use in making and holding popcorn of claim 5, wherein:
each of the upward-pointing triangles being between two adjacent downward-facing triangles.

7. The device for use in making and holding popcorn of claim 5, wherein:
each of the upward-pointing and downward-pointing triangles having a side opposite a respective apex, the sides of each of the upward-pointing triangles being narrower than the sides of each of the downward-pointing triangles.

8. The device for use in making and holding popcorn of claim 1, wherein:
the first panels and the second panels have a triangular shape.

9. The device for use in making and holding popcorn of claim 4, wherein:
the lower portion has a frusto-conical shape.

10. The device for use in making and holding popcorn of claim 5, further comprising:
apertures fluidly coupling an interior of the container with an environment external to the container, the apertures being located at the apexes of the upward-pointing triangles.

11. The device for use in making and holding popcorn of claim 2, further comprising:
apertures fluidly coupling an interior of the container with an environment external to the container.

12. The device for use in making and holding popcorn of claim 1, wherein:
two second panels separate adjacent first panels.

13. The device for use in making and holding popcorn of claim 1, further comprising:
tabs incorporated into the lid section and configured to aid in moving the lid from the closed configuration to the open configuration
